(19) United States
(12) Patent Application Publication
(10) Pub. No.: US 2011/0292699 A1
(43) Pub. Date: Dec. 1, 2011

(54) Systems and Methods for Distortion Reduction

(75) Inventors: Ulrich B. Goerke, Dover, NH (US); Matthew Thomas Murdock, Nashua, NH (US)

(73) Assignee: Texas Instruments Incorporated, Dallas, TX (US)

(21) Appl. No.: 12/788,192

(22) Filed: May 26, 2010

(51) Int. Cl. H02M 7/04

(52) U.S. Cl. 363/84

(57) ABSTRACT

Systems and devices for reduction of total harmonic distortion in power supply circuits are presented. Example embodiments of the disclosed systems of total harmonic distortion reduction reduce a low frequency output voltage ripple seen by the voltage control loop by adding a compensating ripple voltage to the output feedback signal. The compensating signal may be scaled by the user to optimize the degree of ripple reduction, and may be automatically adjusted by monitoring circuitry to scale with a power factor control circuit output power level.

### TECHNICAL FIELD

The present disclosure is generally related to electronics and, more particularly, is related to power supply controllers.

### BACKGROUND

The objective of active power factor correction (PFC) is to make the input to a power supply look like a simple resistor. An active power factor corrector does this by programming the input current in response to the input voltage. As long as the ratio between the voltage and current is a constant the input will appear to be resistive and the power factor will be 1.0. When the ratio deviates from a constant the input will contain phase displacement, harmonic distortion or both and either one will degrade the power factor.

The most general definition of power factor is the ratio of real power to apparent power.

PF=P/(V_{RMS}×I_{RMS})

where P is the real input power and V_{RMS} and I_{RMS} are the root mean square (RMS) voltage and current of the load, or power factor corrector input in this case. If the load is a pure resistance the real power and the product of the RMS voltage and current will be the same and the power factor will be 1.0. If the load is not a pure resistance the power factor will be below 1.0. Phase displacement is a measure of the reactance of the input impedance of the active power factor corrector. Any amount of reactance, either inductive or capacitive will cause phase displacement of the input current waveform with respect to the input voltage waveform. The phase displacement of the voltage and current is the classic definition of power factor which is the cosine of the phase angle between the voltage and current sinusoids.

PF=Cos ⊖

The amount of displacement between the voltage and current indicates the degree to which the load is reactive. If the reactance is a small part of the impedance the phase displacement will be small. An active power factor corrector will generate phase displacement of the input current if there is phase shift in the feed-forward signals or in the control loops. Any filtering of the AC line current will also produce phase displacement.

Harmonic distortion is a measure of the non-linearity of the input impedance of the active power factor corrector. Any variation of the input impedance as a function of the input voltage will cause distortion of the input current and this distortion is the other contributor to reduced power factor.

THD=(1/I₁)×√(I₂²+I₃²+I₄²+ . . . +Iₙ²),

where Iₙ is the harmonic current magnitude.

Distortion increases the RMS value of the current without increasing the total power being drawn. A non-linear load will therefore have a reduced power factor when the RMS value of the current is high but the total power delivered is small. If the non-linearity is small the harmonic distortion will be low. Distortion in an active power factor corrector comes from several sources: the feed-forward signals, the feedback loops, the output capacitor, the inductor and the input rectifiers.

An active power factor correction circuit can easily achieve a high input power factor, usually much greater than 0.9. But power factor is not a sensitive measure of the distortion or the displacement of the current waveform. It is often more convenient to deal with these quantities directly rather than with the power factor. For example, 3% harmonic distortion alone has a power factor of 0.999. A current with 30% total harmonic distortion still has a power factor of 0.95. A current with a phase displacement of 25 degrees from the voltage has a power factor of 0.90. There are heretofore unaddressed needs with distortion in power supply control systems and methods.

### SUMMARY

Example embodiments of the present disclosure provide methods of distortion reduction. In this regard, one embodiment of such a method, among others, can be broadly summarized by the following steps: generating a distortion compensation signal; and superimposing the distortion compensation signal on a voltage sense input port to reduce distortion on an output of a power supply control circuit.

Embodiments of the present disclosure can also be viewed as providing systems for distortion reduction. Briefly described, in architecture, one example embodiment of the system, among others, can be implemented as follows: a power factor correction circuit comprising a sensed voltage input port; and a distortion compensation generator configured to generate a distortion compensation signal to be applied to the sensed voltage input port.

### BRIEF DESCRIPTION OF THE DRAWINGS

FIG. 1 is a circuit diagram of an example embodiment of a prior art non-isolated boost topology circuit implementing power factor correction.

FIG. 2 is a block diagram of an example embodiment of a system of dynamically scaled duty-cycle control used in the disclosed system for distortion reduction.

FIG. 3 is a block diagram of an example embodiment of an ON/OFF state controller circuit used in the disclosed system for distortion reduction.

FIG. 4 is a block diagram of an example embodiment of a compensation generation circuit used in the disclosed system for distortion reduction.

FIG. 5 is a block diagram of an example embodiment of a state generation circuit used in the disclosed system for distortion reduction.

FIG. 6 is a circuit diagram of an example embodiment of a circuit for distortion reduction.

FIG. 7A is a signal diagram of an example embodiment of a ripple voltage used in the circuit of FIG. 6.

FIG. 7B is a signal diagram of an example embodiment of a quasi-square wave compensation signal used in the circuit of FIG. 6.

FIG. 7C is a signal diagram of an example embodiment of a compensated output signal used in the circuit of FIG. 6.

FIG. 8 is a flow diagram of an example embodiment of a method of distortion reduction.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely illustrative examples among other possible examples.

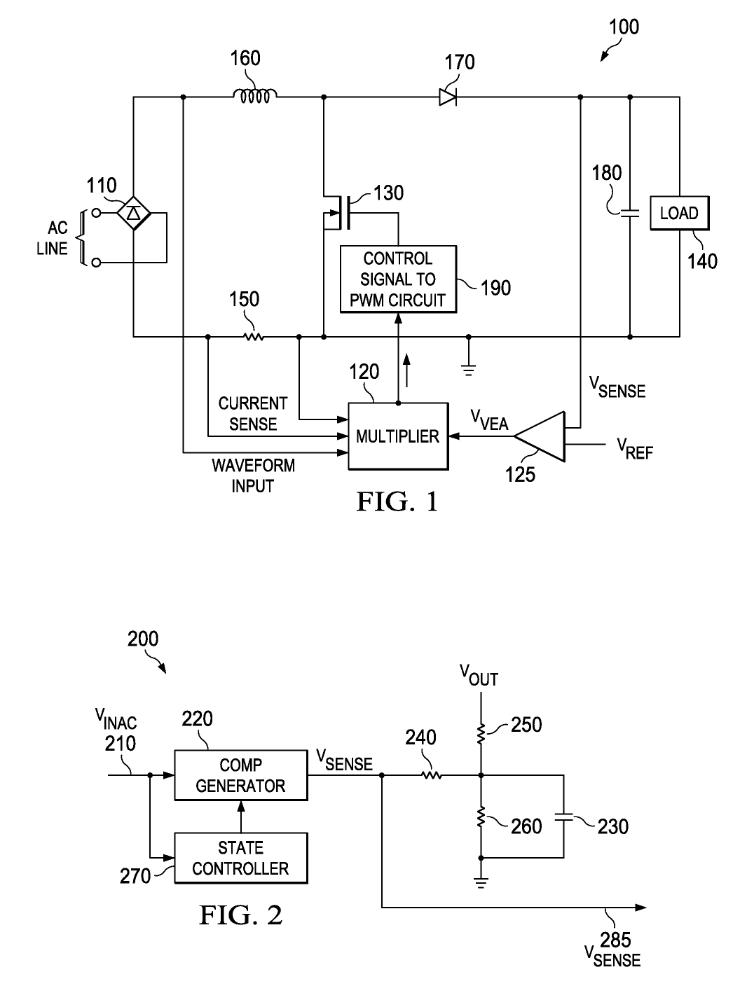

A block diagram of a boost power factor corrector is shown in FIG. 1. The power circuit of a boost power factor corrector is the same as that of a DC to DC boost converter. Diode bridge 110 rectifies the AC input line voltage ahead of inductor 160; but large input capacitor 180, which would normally be associated with the AC to DC conversion function has been moved to the output of the boost converter. If a capacitor follows the input diode bridge it is normally a small one used for noise control, for example. The output of the boost regulator is a nearly constant voltage but the inductor current is programmed by the rectified input voltage to be a half sine wave.

The power flow into output capacitor 180 is not constant, but is a sine wave at twice the line frequency since power is the instantaneous product of voltage and current. Output capacitor 180 stores energy when the input voltage is high and releases the energy when the input voltage is low to maintain the constant output power flow. The charging and discharging current waveform has a different shape from the input current waveform and is almost entirely at the second harmonic of the AC line voltage. This flow of energy into and out of capacitor 180 results in ripple voltage at the second harmonic also. The voltage ripple is displaced by 90 degrees relative to the current since this is reactive energy storage. Output capacitor 180 is rated to handle the second harmonic ripple current as well as the high frequency ripple current from boost converter switch 130 which modulates it, and any ripple currents presented by load 140 (which may typically be another DC-DC converter).

Active power factor correction (PFC) circuit 100 may control both the input current and the output voltage. The current loop may be programmed by the rectified line voltage so that the input to the converter will appear to be resistive. The output voltage is controlled by changing the average amplitude of the current programming signal. Analog multiplier 120 creates the current programming signal by multiplying the rectified line voltage with the output of voltage error amplifier 125 so that the current programming signal has the shape of the input voltage and an average amplitude which controls the output voltage. The output of multiplier 120 is the current programming signal and may be called I_{MO} for multiplier output current. This signal may be converted to a pulse width modulated (PWM) drive signal by PWM block 190 to drive switch 130 with appropriate duty cycles. The output of voltage error amplifier 125 may be divided by the square of the average input voltage before it is multiplied by the rectified input voltage signal. This extra circuitry keeps the gain of the voltage loop constant; without it, the gain of the voltage loop would vary proportionately to the square of the root mean square (RMS) input voltage.

The RMS value of the input voltage is called the feed-forward voltage or V_{FF} since it provides an open-loop correction which is fed forward into the voltage loop. It may be squared and then divided into the output voltage (V_{VEA}) of voltage error amplifier 125. The current programming signal wave-shape matches the rectified line voltage as closely as possible to maximize the power factor. If the voltage-loop bandwidth were large it would modulate the input current to keep the output voltage constant and this would distort the input current. Therefore the voltage loop bandwidth is preferably less than the input line frequency. But the output voltage transient response should be fast so the voltage loop bandwidth should be made as large as possible without contributing to input current distortion.

Squarer and divider circuits may be implemented to maintain constant loop gain so the bandwidth can be as close as possible to the line frequency to maximize the transient response of the output voltage. This is especially important for wide input voltage ranges. The circuits which keep the loop gain constant effectively make the output of voltage error amplifier 125 a power control. The output of voltage error amplifier 125 actually controls the power delivered to the load by controlling the input power level of PFC circuit 100. This can be used to limit the maximum power which the circuit can draw from the power line. If the output of voltage error amplifier 125 is clamped at some value that corresponds to some maximum power level, then active PFC circuit 100 will not draw more than that amount of power from the line as long as the input voltage is within its range.

The control circuits introduce both distortion and displacement into the input current waveform. These errors come from the input diode bridge, the multiplier circuits and ripple voltage, both on the output and on the feed-forward voltage. There are at least two major modulation processes in active PFC circuit 100. The first is input diode bridge 110 and the second is multiplier 120, among others. Each modulation process generates cross products, harmonics or sidebands between the two inputs. The description of these mathematically can be quite complex. Interestingly enough, however, the two modulators interact and one becomes a demodulator for the other so that the result is quite simple. The preponderance of the ripple voltages in PFC circuit 100 are at the second harmonic of the line frequency.

When these voltages pass through multiplier 120, get programmed into the input current, and then pass through input diode bridge 110, the second harmonic voltage amplitude results in two frequency components. One is at the third harmonic of the line frequency and the other is at the fundamental. Both of these components have an amplitude which is half of the amplitude of the original second harmonic voltage. They also have the same phase as the original second harmonic. If, for example, the ripple voltage is 10% of the line voltage amplitude and is phase shifted 90 degrees, the input current will have a third harmonic component which is 5% of the fundamental and is shifted 90 degrees and a fundamental component which is 5% of the line current and is displaced by 90 degrees.

The output voltage has ripple at the second harmonic due to the ripple current flowing through the output capacitor. The amplitude of the output ripple voltage is proportional to the output power level. This ripple voltage is attenuated through voltage error amplifier 125 and applied to multiplier 120 and, like the feed-forward voltage, programs the input current and results in additional second harmonic distortion of the input current. Ideally, the V_{VEA} signal would be a pure DC voltage level, without ripple content, proportional to the output power. In reality, some remnant ripple amplitude still remains super-imposed on the average DC level. This ripple voltage modulates the current-loop control reference signal (I_{MO}) and introduces distortion proportional to the ripple amplitude. The magnitude of this ripple depends on the bandwidth of the voltage error amplifier control loop, which is chosen as a compromise between a reasonable response to line and load transient disturbances and suppressing the ripple to an excessive degree. A wide (high) bandwidth loop would keep the PFC output voltage better regulated in response to line and load disturbances at the expense of high distortion on the input current.

Conversely a very low bandwidth loop would introduce very little distortion from the output ripple at the expense of severe under shoot and overshoot of the PFC output voltage in response to line and load disturbances. Since this ripple voltage does not go through a squarer the amplitude of the distortion and displacement are each half of the amplitude of the ripple voltage. The ripple voltage at the output of voltage error amplifier 125 must be in phase with the line voltage for the displacement component to be in phase. Voltage error amplifier 125 must shift the second harmonic by 90 degrees so that it will be in phase with the line voltage.

The voltage loop of a boost converter with average current mode control has a control to output transfer function which has a single pole roll off characteristic so it could be compensated with a flat gain error amplifier. This produces a very stable loop with 90 degrees of phase margin. However, it provides less than optimum performance. If the error amplifier has flat gain at the second harmonic frequency, the distortion and displacement generated in the input current will be 90 degrees out of phase with the rectified AC line. The power factor can be improved by introducing phase shift into the response of voltage error amplifier 125. This shifts the displacement component of the power factor back into alignment with the input voltage and increases the power factor. The amount of phase shift which can be added is determined by the need to keep the voltage loop stable.

If the phase margin is reduced to 45 degrees the phase at the second harmonic will be very close to 90 degrees and this brings the displacement component back in phase with the input voltage. The bandwidth of the voltage control loop is determined by the amount of input distortion to be contributed by the output ripple voltage. If the output capacitor is small and the distortion must be low then the bandwidth of the loop must be low so that the ripple voltage will be sufficiently attenuated by the error amplifier.

Transient response is a function of the loop bandwidth and the lower the bandwidth the slower the transient response and the greater the undershoot or overshoot. The output capacitor may need to be large to have both fast output transient response and low input current distortion. A technique used to design the loop compensation may include finding the amount of attenuation of the output ripple voltage required in voltage error amplifier 125 and then work back into the unity gain frequency. The loop will have the maximum bandwidth when the phase margin is the smallest. A 45 degree phase margin is a good compromise which will give good loop stability and fast transient response and which is easy to design. The resulting response of voltage error amplifier will have flat gain up to the loop unity-gain frequency and will have a single pole roll off above that frequency. This gives the maximum amount of attenuation at the second harmonic of the line frequency from a simple circuit, gives the greatest bandwidth, and provides a 45 degree phase margin.

The disclosed systems and methods of distortion reduction superimpose a compensation signal at the feedback voltage sense input of a power supply circuit. In an example embodiment, the power supply circuit is a power factor controller circuit. The superimposed signal is a compensating signal injected in a closed loop such that the amplitude of the compensating signal is, in part, dependent on the average amplitude of the error voltage coming from error amplifier 125. Error amplifier 125 may be filtered through a DC filter to a very low frequency level. The ripple on the output is partly pre-cancelled, but the degree of cancellation is dependent on the DC level of the output. The average level of the error voltage determines, in part, how much cancellation to put in. As previously stated, the magnitude of the output ripple voltage seen by the voltage-loop error amplifier at the feedback input is proportional to the PFC output power. Also, as previously stated, the average level of the error voltage is proportional to the average output power. Therefore, the average level of the error voltage can be used to proportionally control the amplitude of the compensation signal to be super-imposed upon the feedback signal. Ideally, the compensation signal would be an exact inverse replica of the ripple voltage on the feedback signal. In analog-IC implementations, such a compensating signal would be difficult and complicated to construct. In digital-IC implementations, it may require significant computation time and DSP resources to construct the signal. Approximations to the actual ripple, such as piece-wise linear, trapezoidal, quasi-square and fully-square waves represent signals of successively less accuracy, but successively greater simplicity. In one particular embodiment, a quasi-square wave signal represents a suitable compromise for effective reduction of distortion while maintaining simplicity of implementation.

FIG. 2 provides a block diagram of an example embodiment of a system of distortion reduction. Compensation generator 220 receives input AC waveform V_{INAC} 210 and generates a compensation signal that is applied to V_{SENSE} 285. Compensation generator 220 may also receive input from state generator 270. In an example embodiment, on/off state generator 270 determines when the state of the compensation signal switches from a low logic signal to a high logic signal or from a high logic signal to a low logic signal. In an example embodiment, the compensation signal super-imposed on V_{SENSE} 285 is set with resistor 240. A bias voltage for the compensation signal to V_{SENSE} is set with resistor 250 and resistor 260. Capacitor 230 provides low pass filtering for the compensation signal.

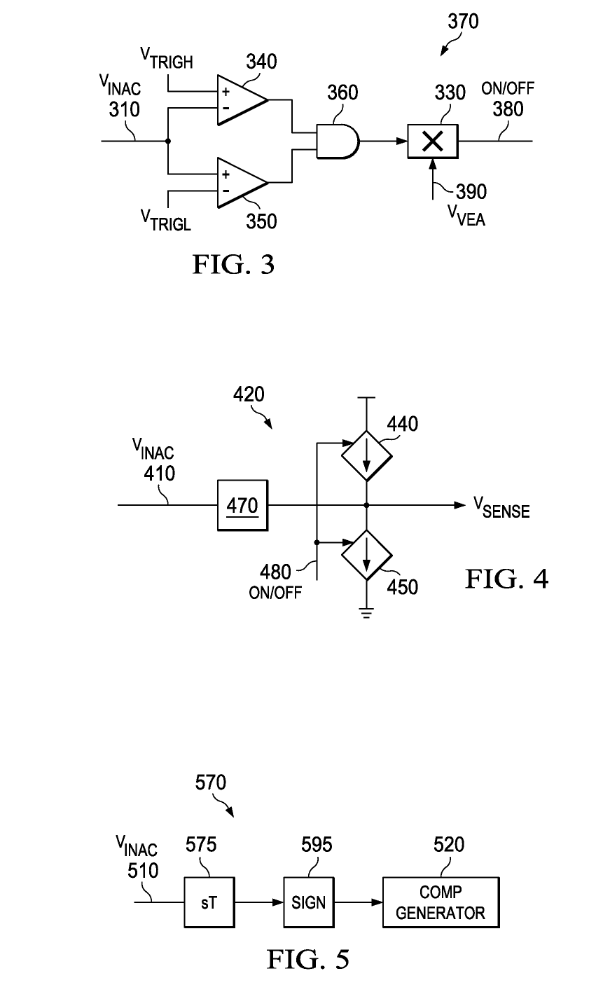

FIG. 3 provides a block diagram of on/off state controller 370. As described in FIG. 2, on/off state controller 370 determines the input voltage levels at which the state of the compensation signal switches from a low logic signal to a high logic signal or from a high logic signal to a low logic signal. In the example embodiment of on/off state controller 370 in FIG. 3, input AC voltage V_{INAC} 310 is presented to a window comparator comprising comparators 340 and 350. In this embodiment, V_{INAC} 310 is compared to a high trigger voltage V_{TRIGH} with comparator 340 and a low trigger voltage V_{TRIGL} with comparator 350. The outputs of comparators 340 and 350 are communicatively coupled to AND gate 360. In this embodiment, if V_{INAC} 310 is between V_{TRIGH} and V_{TRIGL}, the output of AND gate 360 is high; otherwise, the output of AND gate 360 is low. The output of AND gate 360 is multiplied by V_{VEA} 390 in multiplier 330. V_{VEA} 390 is the output of the error amplifier. The output of multiplier 370 is ON/OFF signal 380, which sets the level of the compensation signal.

In an example embodiment, V_{TRIGH} may be 12.4 volts and V_{TRIGL} may be 2.6 volts. The window comparator implements the quasi-square wave. The window comparator turns on the current source when the input voltage is at 2.6 volts, and turns it off when the input voltage reaches about 12.4 volts before the rectified sine wave has reached the peak. The current source will stay off through the peak, until the input voltage goes below 12.4 volts again. Then the current source turns back on with the same amplitude but opposite polarity and stays on until the input voltage goes below 2.6 volts. Below 2.6 volts, the current source is again turned off. So the current source is on twice for each rectified sine wave. It's on just after the zero crossing when it's going towards the peak and shuts off at the peak, then it turns on again right after the peak until it gets near the zero crossing and then it shuts off again. So, in this example embodiment, the current source is actually on twice for every half cycle; once in a positive polarity and once in a negative polarity.

FIG. 4 provides a block diagram of an example embodiment of compensation generator 420. There are many ways to generate the compensation signal. In this example embodiment, the compensation signal is generated with current sources 440 and 450. One of current sources 440 and 450 may be a current source and the other of current sources 440 and 450 may be a current sink. In this example embodiment, ON/OFF signal 480 selects the current source or the current sink and affects the magnitude of the current. State generator 470 selects the current source or the current sink function. The current sources could be a sine wave or a trapezoidal current source. Additionally, digital implementations may perform wave shaping of the current instead of just turning it on and off. In an alternative embodiment, a digital signal processor (DSP) could just calculate the compensation necessary. The DSP may sense the ripple on the output. To maintain an appropriate point of reference for the DSP, the sensing may be performed periodically to recalibrate. Alternatively, the worst case scenario may be determined and the compensation may be set under that condition. In an example embodiment, the systems and methods of distortion reduction may be internal to a semiconductor device, or they could be added external to an already existing device.

FIG. 5 provides a block diagram of an example embodiment of state generator 570. State generator 570 selects the current source or the current sink function for compensation generator 520. V_{INAC} 510 is input to differentiator 575, which generates a slope signal from the input AC waveform. Sign block 595 generates a +1 or a −1 signal based on whether the slope of the output of differentiator 575 is positive or negative respectively. In this example embodiment, if sign block 595 generates a +1, the current sink is selected in compensation generator 520. If sign block 595 generates a −1, the current source is selected in compensation generator 520. Alternatively, the output signal of sign block 595 is fed into a multiplier which multiplies a single current source by 1 or negative 1, provided said current source is able to both sink and source current to a node.

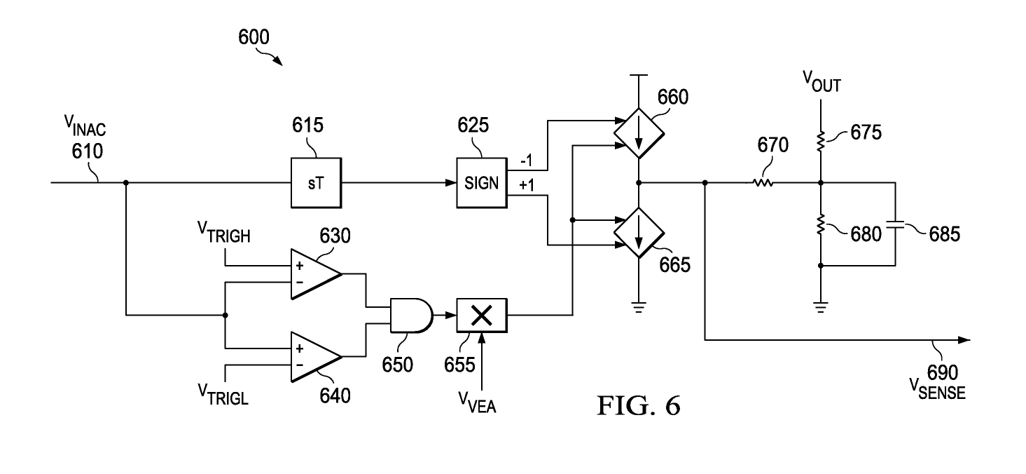

FIG. 6 provides circuit block diagram 600 of an example embodiment of a system of distortion reduction. In this example embodiment, the input is V_{INAC} 610 which may be an attenuated, rectified AC line voltage. V_{INAC} 610 is applied to differentiator 615 and to a window comparator comprising comparators 630 and 640. Differentiator 615 produces a slope signal from V_{INAC} 610. The slope signal produced by differentiator 615 is applied to sign block 625. A positive slope into sign block 625 produces a +1 output, and a negative slope into sign block 625 produces a −1 output. A +1 from sign block 625 turns on current source 660, and a −1 output from sign block 625 turns on current source 665.

In this example embodiment, V_{INAC} 610 is also communicatively coupled to a window comparator comprising comparators 630 and 640. Comparator 630 compares V_{INAC} 610 to V_{TRIGH} and comparator 640 compares V_{INAC} 610 to V_{TRIGL}. The outputs of comparators 630 and 640 are communicatively coupled to AND gate 650, such that the output of AND gate 650 is a logic high when V_{INAC} is between V_{TRIGH} and V_{TRIGL}. The output of AND gate 650 is communicatively coupled to multiplier 655 where the output of AND gate 650 is multiplied by the output of the error amplifier. The output of multiplier 655 controls the magnitude of the compensation signal generated by current sources 660 and 665. Resistor 670 controls the amplitude of the compensation signal applied to V_{SENSE} 690. Resistors 675 and 680 set a bias voltage for the feedback signal at V_{SENSE} 690. Capacitor 685 filters high frequency components of the feedback signal.

An example embodiment using the circuit of FIG. 6 implements current sources 660 and 665 that are controlled in proportion to the output of the error amplifier to achieve a particular magnitude. This magnitude is multiplied by the current source factor to generate the compensation signal. In this example embodiment, current sources 660 and 665 may be 2.5 microamps based on the output of the error amplifier. The output signal of sign block 625 determines whether the current should be a positive current or a negative current. The V_{INAC} input to the compensation generator may be a rectified line voltage. The rectified sine wave may be divided down by an amount dependent on the particular application. It may be applied through a buffer so that the input signal is not loaded down. The V_{INAC} input signal goes through differentiator 615 and the sign of the slope is determined with sign block 625. If the rectified sine wave has a positive slope, the output of sign block 625 is a +1. After the rectified sine wave crosses over the peak, the slope goes negative and the output of sign block 625 is a −1. The current source then is multiplied by −1 or +1 depending on the rising or falling slopes of the input sine waves, or −1 selects the current source and +1 selects the current sink.

In the example embodiment of FIG. 6, the current source is implemented with negative current source 665 and positive current source 660. The polarity of the current is determined by whether the rectified sine wave has a positive slope or a negative slope. Positive current source 660 is turned on during the positive slope of the input signal and negative current source 665 is turned on during the negative slope of the input signal. This is one non-limiting example. There may be other possibilities for generating the current source and sinks. It may be preferable to adjust the level of the signal from the error amplifier to match the bias level of the current source.

Rectified sine wave V_{INAC} 610 may also be applied to a comparative block with user variable thresholds. The comparative block in this embodiment comprises comparators 630 and 640. In a non-limiting example embodiment, the thresholds may be selected to be 12.4 volts and 2.6 volts as voltage levels to enable the current source. The outputs of comparators 630 and 640 are input into AND gate 650. This output of AND gate 650 is either zero or one. So the output of the error amplifier, V_{VEA}, is multiplied by zero or one in multiplier 655. So, in this example embodiment, the current source would be off (zero current) or a value equal to the current source value times V_{VEA} from the output of the error amplifier. So differentiator 615 and sign block 625 generate the sign of the circuit and the output of comparators 630 and 640 and AND gate 650 multiplied by V_{VEA} gives the value of the current for the compensation signal.

The voltage applied to V_{SENSE} input 690 is the current source value multiplied by the output of sign block 625, multiplied by the output of ON/OFF state generator 655, multiplied by the value of resistor 670. In an example embodiment, a 10K resistor may be used for resistor 670 and a 2.5 microamp current source for current sources 660 and 665. If the 10K resistor is decreased to a 1K resistor, to get the same voltage signal, the current sources would be increased to 22.5 microamps. On the other hand, if resistor 670 is changed to 100K, then current sources 660 and 665 would be changed to 0.2 microamps to get the net effect of the same voltage at the V_{SENSE} input.

The 10K and the 2.25 microamps values for resistor 670 and current sources 660 and 665 are dependent on the particular application. The value of resistor 670 is dependant on the value of current sources 660 and 665. The current source may be selected based on semiconductor limitations. The selected value may be within manufacturable tolerances. So it's going to be on the order of a microamp. The higher the current source, the lower the resistance value. However, the resistance value impacts the current into the V_{SENSE} 690. Zero additional current into the sense node is preferred, because the additional current generates an offset current or a bias current that affects the accuracy of the output. Ideally, the V_{SENSE} 690 is strictly a voltage node with no appreciable bias current. The bias current may typically be in the nanoamp range. However, when the compensating current is introduced, it will have some effect on the voltage reading. So, 2.25 microamps is a typical value and the 10K resistor is selected to align the super-positioning of the distortion compensation signal.

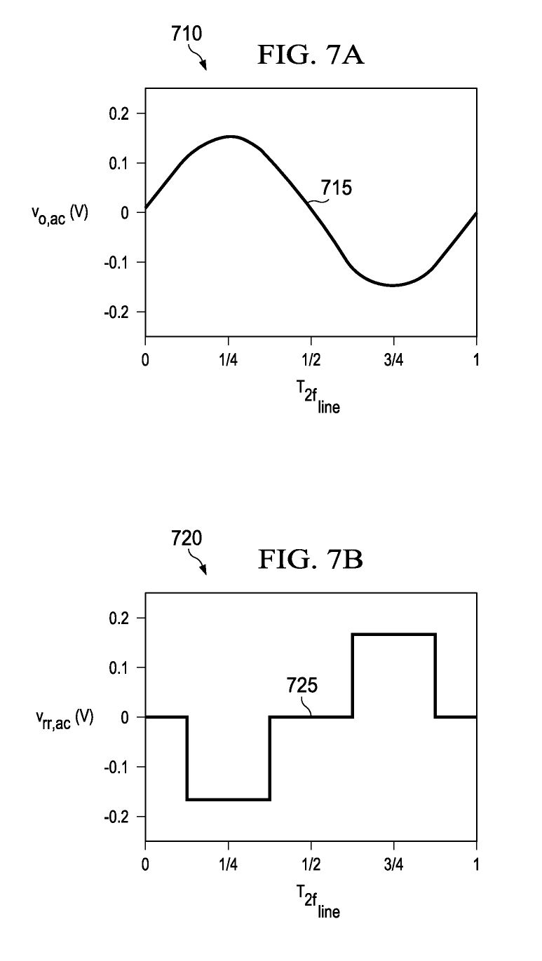

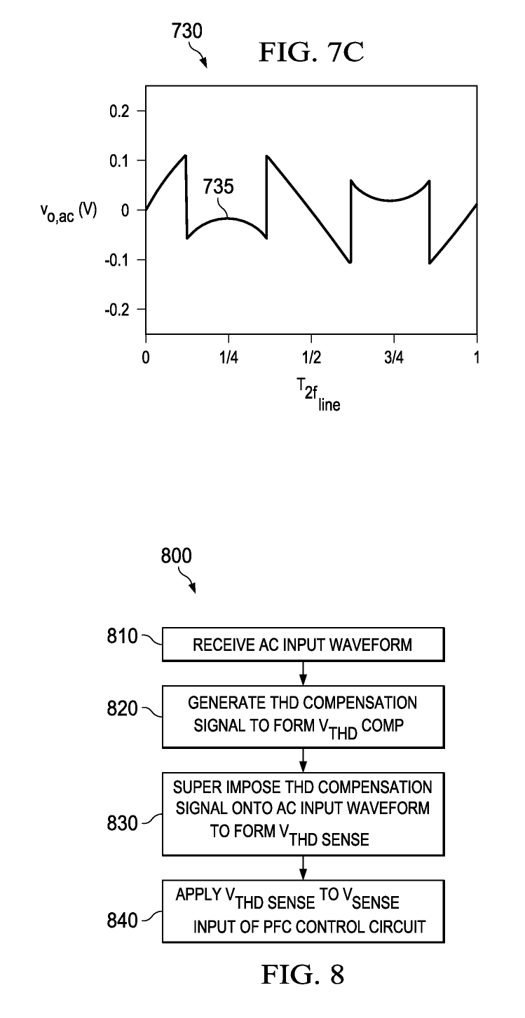

Practically speaking, it is desirable to have as small a current source as possible, but not so small that the current source is unmanufacturable. The designer should determine how much ripple is in the overall design. In some designs, this may be in the realm of 40 millivolts peak to peak ripple on the feedback signal, which may be attenuated from 400 volts in a particular application. The compensating square wave subtracts 20 millivolts (so roughly half that voltage) to reduce the peak-to-peak voltage at the error amplifier input. The resulting compensated wave form as shown in FIG. 7C has reduced the low frequency content and increased the high frequency content applied to the V_{SENSE} pin of the power factor correction semiconductor device. Therefore, the error amplifier bandwidth can better attenuate the high frequency content and result in an error voltage with substantially less ripple.

The PFC semiconductor device is not affected by the superimposed distortion compensation signal. All it sees at the V_{SENSE} input is an input voltage. That input voltage has been modified from a high-ripple low-frequency signal to a low-ripple high-frequency signal. So the distortion attributed to the error amplifier loop is attenuated. The net result is the output ripple of the error amplifier is attenuated more because of the higher frequency content. The error amplifier output is smoother. So the resulting effect on the distortion is highly improved. In a particular application, a designer may know how much ripple is on the PFC output. Designers wish to decrease the cost and component size. The resulting effect is decreased filtering, and the decreased filtering leads to higher distortion on the input current. The systems and methods of distortion reduction disclosed herein allow for a high output ripple voltage by canceling a large amount of it before it gets fed back into the V_{SENSE} input.

FIG. 7A, FIG. 7B, and FIG. 7C provide signal diagrams of an example embodiment of systems and methods of distortion reduction as disclosed herein. In FIG. 7A, signal diagram 710 provides input AC waveform 715. In FIG. 7B, signal diagram 720 provides quasi-square wave compensation signal 725 formed with the current sources. In FIG. 7C, signal diagram 730 provides compensated signal 735 which is formed from the superposition of signals 715 and 725. AC waveform 715 is the ripple voltage on output capacitor 180. After signals 715 and 725 are combined at resistor 670, the waveform is a step and then a slope up or down representing the slopes of ripple sine wave 715. During the positive slope time there is a negative current, so quasi-square wave 725 is below the zero axis. During the negative slope, quasi-square wave 725 is above the zero axis. Quasi-square wave 725 may be considered as a rectangular wave with some dead time. The dead time period provides a controllable degree of cancellation. When the amplitude of the quasi-square wave is scaled by the output of the error amplifier, it produces a variable-offset sine wave with a “zig-zag” at the zero crossing. Signal 735 is the sine wave added with the quasi-square wave. The resulting waveform is reduced in amplitudes where the original peaks were, with a “zig-zag” straddling the zero crossings.

Without the systems and methods provided herein, a high ripple voltage goes into the error amplifier and the error amplifier is used to filter out the ripple voltage. However it uses relatively little bandwidth to perform this function at low frequency. If the ripple voltage is not filtered by the error amplifier, the output will also have a large amount of ripple voltage on it and that ripple leads to excessive input current distortion. Ideally, the output of the error amplifier should have no ripple. With the systems and methods of distortion reduction disclosed herein, that ripple is reduced before the error amplifier input so that the filtering function of the error amplifier is improved. One approach, as disclosed herein, is to cancel that ripple with an approximate opposite ripple, or, in other words, use a quasi-square wave with some dead time at the zero crossings. The net result is that the input of the error amplifier has a smaller ripple at higher frequencies which can be easily filtered to achieve a nearly flat output without decreasing bandwidth. The loop bandwidth of the error amplifier may be higher for faster transient response and still achieve low harmonic distortion.

FIG. 8 provides a flow diagram of an example embodiment of a method of distortion reduction as disclosed herein. In block 810, an AC input waveform is received. This may be an attenuated sample of a PFC output ripple voltage or rectified voltage. In block 820, a compensation signal, V_{THDCOMP}, is generated. In block 830, V_{THDCOMP} is superimposed onto the AC input waveform to form V_{VTHDSENSE}. In block 840, V_{THDSENSE} is applied to the sense input of a power factor control circuit voltage-loop error amplifier.

Although the present invention has been described in detail, it should be understood that various changes, substitutions and alterations can be made thereto without departing from the spirit and scope of the invention as defined by the appended claims.

Therefore, at least the following is claimed:

1. A system comprising:
a power factor correction control circuit comprising a sensed voltage input port; and
a distortion compensation generator configured to generate a distortion compensation signal to be applied to the sensed voltage input port.

2. The system of claim 1, wherein the distortion compensation signal is derived from a rectified sine wave, which generates a quasi-square wave with dead time at the zero crossings.

3. The system of claim 2, wherein the rectified sine wave is an attenuated rectified version of an alternating current input voltage source.

4. The system of claim 2, further comprising a state controller to control when the quasi-square wave is positive with respect to the zero crossing or negative with respect to the zero crossing.

5. The system of claim 4, wherein the state controller comprises at least one comparator configured to set an on-state level and/or an off-state level of the quasi-square wave.

6. The system of claim 2, wherein the quasi-square wave is generated with a first constant current source, configured to source or sink current to produce the quasi-square wave.

7. The system of claim 2, further comprising two constant current sources, wherein the first constant current source is configured to source current, and the second constant current source is configured to sink current in producing the quasi-square wave.

8. The system of claim 1, wherein a magnitude of the distortion compensation signal is affected by an output of a voltage-loop error amplifier of the power factor correction control circuit.

9. A method, comprising:
generating a distortion compensation signal; and
superimposing the distortion compensation signal on a voltage sense input port to reduce distortion on an output of a power supply control circuit.

10. The method of claim 9, wherein the distortion compensation signal comprises an attenuated version of an input signal summed with a quasi-square wave with dead time at the zero crossing of the quasi-square wave.

11. The method of claim 9, wherein generating a distortion compensation signal further comprises:
rectifying and attenuating an alternating current (AC) input voltage;
generating a sign component from the slope of the rectified attenuated AC input voltage;
setting a magnitude of the distortion compensation signal; and
setting a dead time of a quasi-square wave.

12. The method of claim 11, wherein setting the dead time of the quasi-square wave comprises comparing the rectified attenuated AC input voltage to at least one reference voltage.

13. The method of claim 11, wherein the magnitude of the distortion compensation signal comprises multiplying a current source by an output of an error amplifier of the power supply control circuit.

14. A power supply control circuit comprising:
a power factor controller circuit with an attenuated, rectified, alternating current (AC) voltage input, a voltage sense input, and an error amplifier output; and
a distortion compensation circuit electrically connected to the AC voltage input, the error amplifier output, and the voltage sense input of the power factor controller circuit, the distortion compensation circuit configured to superimpose a distortion compensation signal on the voltage sense input to reduce distortion on an output of the power factor controller circuit.

15. The power supply control circuit of claim 14, further comprising a distortion compensation signal generator configured to generate the distortion compensation signal, the distortion compensation signal generator comprising at least one current source controlled by a state generator and a slope detector.

16. The power supply control circuit of claim 15, wherein the slope detector detects a slope of a ripple on the attenuated, rectified, AC input voltage to the power factor controller circuit.

17. The power supply control circuit of claim 14, wherein the distortion compensation signal comprises a quasi-square wave with dead time at the zero crossings summed with an attenuated AC ripple voltage.

18. The power supply control circuit of claim 17, further comprising a state controller comprising at least one comparator configured to set an on-state level and/or an off-state level of the quasi-square wave.

19. The power supply control circuit of claim 17, wherein the quasi-square wave is generated with a first constant current source, configured to source or sink current to produce the quasi-square wave.

20. The power supply control circuit of claim 15, wherein a magnitude of the distortion compensation signal is affected by an output of the error amplifier of the power factor controller circuit.
